(19) United States
(12) Patent Application Publication
(10) Pub. No.: US 2017/0374667 A1
(43) Pub. Date: Dec. 28, 2017

(54) POWER EFFICIENT DYNAMIC RADIO ACCESS TECHNOLOGY SELECTION

(71) Applicant: QUALCOMM Incorporated, San Diego, CA (US)

(72) Inventors: Bhaskara Viswanadham Batchu, Ameenpur Village (IN); Soumen Mitra, Hyderabad (IN)

(21) Appl. No.: 15/190,524

(22) Filed: Jun. 23, 2016

(51) Int. Cl. H04W 72/04; H04W 52/50

(52) U.S. Cl. CPC H04W 72/0473; H04W 52/50

(57) ABSTRACT

Methods, systems, and devices for wireless communication are described that provide for power management of wireless devices by selecting a radio access technology (RAT) from multiple RATs for communication. A wireless device may determine power usage for a data transmission for each of multiple RATs and transmit the data based at least in part on a the determined power usages. The power usage for different RATs may be determined based at least in part on channel conditions, average power, RAT throughput, or variance, among other factors.

### BACKGROUND

The following relates generally to wireless communication, and more specifically to power efficient dynamic radio access technology selection.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, (e.g., a Long Term Evolution (LTE) system). A wireless multiple-access communications system may include a number of base stations, each simultaneously supporting communication for multiple communication devices).

Wearable, Internet of Things (IoT), or other multimode devices may include low-power multimode modems capable of supporting multiple Radio Access Technologies (RATs). Depending on coverage availability, a wearable/IoT device may be capable of connecting to multiple RATs. While different RATs offer different capabilities, a wearable/IoT device may choose to select a RAT for communication based at least in part on RAT priority and coverage area. For example, a wearable/IoT device may select a high priority RAT provided that the device is within a coverage area for the high priority RAT. In such cases, even if a small amount of data is being communicated, communicating using a higher priority RAT may drain more power than communicating using a lower priority RAT.

### SUMMARY

The described techniques relate to improved methods, systems, devices, or apparatuses that support power efficient dynamic radio access technology selection. Generally, the described techniques provide for managing power usage of a multimode device by determining, for different RATs, power usage for a fixed amount of data to be transmitted. Based at least in part on the determined power usages for different RATs, the multimode device may choose to transmit the fixed amount of data using a RAT that consumes less power, even if the selected RAT has lower data rate capabilities or lower priority in a list of RATs.

A method of wireless communication is described. The method may include determining a first power usage of a first radio access technology (RAT) for transmission of a data packet based at least in part on a first estimated time to transmit a fixed amount of data associated with the data packet using the first RAT, determining a second power usage of a second RAT for transmission of the data packet based at least in part on a second estimated time to transmit the fixed amount of data associated with the data packet using the second RAT, and transmitting, based at least in part on the determined first power usage and the determined second power usage, the data packet according to one from the group consisting of the first RAT and the second RAT.

An apparatus for wireless communication is described. The apparatus may include means for determining a first power usage of a first radio access technology (RAT) for transmission of a data packet based at least in part on a first estimated time to transmit a fixed amount of data associated with the data packet using the first RAT, means for determining a second power usage of a second RAT for transmission of the data packet based at least in part on a second estimated time to transmit the fixed amount of data associated with the data packet using the second RAT, and means for transmitting, based at least in part on the determined first power usage and the determined second power usage, the data packet according to one from the group consisting of the first RAT and the second RAT.

Another apparatus for wireless communication is described. The apparatus may include a processor, memory in electronic communication with the processor, and instructions stored in the memory. The instructions may be operable to cause the processor to determine a first power usage of a first radio access technology (RAT) for transmission of a data packet based at least in part on a first estimated time to transmit a fixed amount of data associated with the data packet using the first RAT, determine a second power usage of a second RAT for transmission of the data packet based at least in part on a second estimated time to transmit the fixed amount of data associated with the data packet using the second RAT, and transmit, based at least in part on the determined first power usage and the determined second power usage, the data packet according to one from the group consisting of the first RAT and the second RAT.

A non-transitory computer readable medium for wireless communication is described. The non-transitory computer-readable medium may include instructions operable to cause a processor to determine a first power usage of a first radio access technology (RAT) for transmission of a data packet based at least in part on a first estimated time to transmit a fixed amount of data associated with the data packet using the first RAT, determine a second power usage of a second RAT for transmission of the data packet based at least in part on a second estimated time to transmit the fixed amount of data associated with the data packet using the second RAT, and transmit, based at least in part on the determined first power usage and the determined second power usage, the data packet according to one from the group consisting of the first RAT and the second RAT.

With reference to the method, apparatus, and non-transitory computer-readable medium described above, a first estimated throughput for the first RAT and a second estimated throughput for the second RAT can be determined. The first power usage may be based at least in part on the first estimated throughput and the second power usage may be based at least in part on the second estimated throughput.

A first average power usage for the first RAT and a second average power usage for the second RAT may be determined, and the first power usage may be based at least in part on the first average power usage and the second power usage may be based at least in part on the second average power usage.

A variance of at least one of the first average power usage or the second average power usage may be determined, and at least one of the first power usage or the second power usage may be based at least in part on the determined variance.

A rate of power usage change for at least one of the first RAT or the second RAT may be determined, and at least one of the first power usage or the second power usage may be based at least in part on the determined rate of power usage change.

At least one of the first power usage or the second power usage may be based at least in part on a modulation and coding scheme (MCS) associated with at least one of the first RAT or the second RAT.

At least one of the first power usage or the second power usage may be based at least in part on channel conditions associated with at least one of the first RAT or the second RAT.

Transmitting the data packet comprises: generating an ordered table including the first RAT and the second RAT, the ordered table being based at least in part on the determined first power usage and the determined second power usage. One of the first RAT or the second RAT may be selected to transmit the data packet based at least in part on an ordering of the first RAT and the second RAT in the ordered table.

### BRIEF DESCRIPTION OF THE DRAWINGS

FIG. 1 illustrates an example of a system for wireless communication that supports power efficient dynamic radio access technology selection in accordance with aspects of the present disclosure.

FIG. 2 illustrates an example of a system for wireless communication that supports power efficient dynamic radio access technology selection in accordance with aspects of the present disclosure.

FIG. 3A illustrates an example of a frame structure that supports power efficient dynamic radio access technology selection in accordance with aspects of the present disclosure.

FIG. 3B illustrates an example of radio access technology selection in accordance with aspects of the present disclosure.

FIGS. 4A and 4B illustrate examples of power efficient dynamic radio access technology selection in accordance with aspects of the present disclosure.

FIGS. 5A and 5B illustrate block diagrams of a station that supports power efficient dynamic radio access technology selection in accordance with aspects of the present disclosure.

FIG. 6 illustrates a method for power efficient dynamic radio access technology selection in accordance with aspects of the present disclosure.

### DETAILED DESCRIPTION

A multimode wireless device, such as an Internet of Things (IoT) device, may be capable of communicating using multiple radio access technologies (RATs), each of which may offer different capabilities such as data rate, channel conditions, signal strength, power usage, etc. Some multimode devices may be low-power wireless devices that operate using a battery and are active for a relatively short period of time while remaining inactive for a relatively long period of time. During the short active period, a fixed amount of data may be scheduled to be transmitted from the wireless device to a serving station, such as a base station. If the device is located within multiple coverage areas associated with the different RATs, the device selects one of the multiple RATs for communication.

In selecting a RAT, the device may refer to a priority list of RATs and select the highest priority RAT from the list that is available for communication. In such scenarios, however, the device may select a RAT that drains more power than other available RATs. As some devices may benefit from limiting the amount of power used when transmitting data, the present disclosure provides for methods, systems, and devices that determine power usage for data transmission using different RATs. Based at least in part on the determination, the device may select a RAT for communication.

Aspects of the above disclosure are described below in the context of a wireless communications system. Aspects of the disclosure are further illustrated by and described with reference to apparatus diagrams, system diagrams, and flowcharts that relate to power efficient dynamic RAT selection.

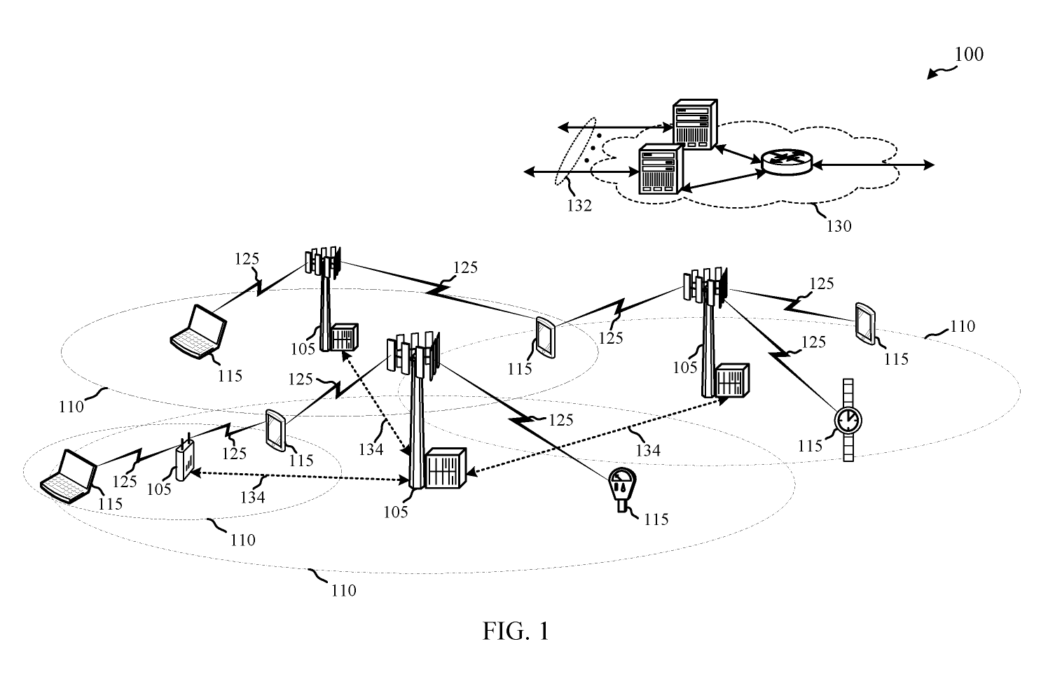

FIG. 1 illustrates an example of a wireless communications system 100 in accordance with various aspects of the present disclosure. The wireless communications system 100 includes base stations 105, wireless devices 115, and a core network 130. In some examples, the wireless communications system 100 may support communication for multiple RATs, such as Long Term Evolution (LTE)/LTE-Advanced (LTE-A), high data rate (HDR), evolution-data optimized (EV-DO), Universal Mobile Telecommunications System (UMTS), etc.

Base stations 105 may wirelessly communicate with wireless devices 115 via one or more base station antennas. Each base station 105 may provide communication coverage for a respective geographic coverage area 110. Communication links 125 shown in wireless communications system 100 may include uplink transmissions from a wireless device 115 to a base station 105, or downlink transmissions, from a base station 105 to a wireless device 115. Wireless devices 115 may be dispersed throughout the wireless communications system 100, and each wireless device 115 may be stationary or mobile. A wireless device 115 may also be referred to as a mobile station, a subscriber station, a remote unit, a station (STA), a user equipment (UE), an access terminal (AT), a handset, a user agent, a client, or like terminology. A wireless device 115 may also be a cellular phone, a wireless modem, a handheld device, a personal computer, a tablet, a personal electronic device, an machine type communication (MTC) device, an IoE device, a multimode device, etc.

Base stations 105 may communicate with the core network 130 and with one another. For example, base stations 105 may interface with the core network 130 through backhaul links 132 (e.g., S1, etc.). Base stations 105 may communicate with one another over backhaul links 134 (e.g., X2, etc.) either directly or indirectly (e.g., through core network 130). Base stations 105 may perform radio configuration and scheduling for communication with wireless devices 115, or may operate under the control of a base station controller (not shown). In some examples, base stations 105 may be macro cells, small cells, hot spots, or the like.

In some cases, wireless communications system 100 may utilize one or more enhanced component carriers (eCCs). An eCC may be characterized by one or more features including: flexible bandwidth, different transmission time intervals (TTIs), and modified control channel configuration. In some cases, an eCC may be associated with a carrier aggregation (CA) configuration or a dual connectivity configuration (e.g., when multiple serving cells have a suboptimal backhaul link). An eCC may also be configured for use in unlicensed spectrum or shared spectrum (e.g., where more than one operator is licensed to use the spectrum).

An eCC characterized by flexible bandwidth may include one or more segments that may be utilized by wireless devices 115 that are not capable of monitoring the whole bandwidth or prefer to use a limited bandwidth (e.g., to conserve power). In some cases, an eCC may utilize a different TTI length than other component carriers (CCs), which may include use of a reduced or variable symbol duration as compared with TTIs of the other CCs. The symbol duration may remain the same, in some cases, but each symbol may represent a distinct TTI. In some examples, an eCC may support transmissions using different TTI lengths. For example, some CCs may use uniform lms TTIs, whereas an eCC may use a TTI length of a single symbol, a pair of symbols, or a slot. In some cases, a shorter symbol duration may also be associated with increased subcarrier spacing.

In conjunction with the reduced TTI length, an eCC may utilize dynamic time division duplex (TDD) operation (i.e., an eCC may switch from DL to UL operation for short bursts according to dynamic conditions). Flexible bandwidth and variable TTIs may be associated with a modified control channel configuration (e.g., an eCC may utilize an enhanced physical downlink control channel (ePDCCH) for DCI). For example, one or more control channels of an eCC may utilize frequency-division multiplexing (FDM) scheduling to accommodate flexible bandwidth use. Other control channel modifications include the use of additional control channels (e.g., for evolved multimedia broadcast multicast service (eMBMS) scheduling, or to indicate the length of variable length UL and DL bursts), or control channels transmitted at different intervals. An eCC may also include modified or additional HARQ related control information.

In some cases, as discussed above, a wireless device 115 may be a low-power device that transmits a small amount of fixed-length data periodically. However, even if a wireless device 115 is a low-power device, the wireless device 115 may choose to connect to a high priority RAT that consumes more power. This may result in an unnecessary drain of power as the wireless device 115 may be incapable of supporting the data rate provided by the higher priority RAT. Further, the wireless device 115 may not consider channel conditions associated with the selected RAT, which may result in retransmission of data due to poor channel conditions, resulting in additional power draining for each retransmission. Therefore, in order to consume less power, it may be more efficient for the wireless device 115 to connect to a lower data rate RAT or a lower priority RAT as opposed to connecting to a high data rate or high priority RAT.

To do so, the wireless device 115 may determine a power usage of a first RAT for a fixed data length transmission. The wireless device 115 may also determine power usage of a second RAT for the same fixed data length transmission. In some examples, based at least in part on the difference in determined power usage for each RAT, the wireless device 115 may choose to communicate according to one of the first RAT or the second RAT.

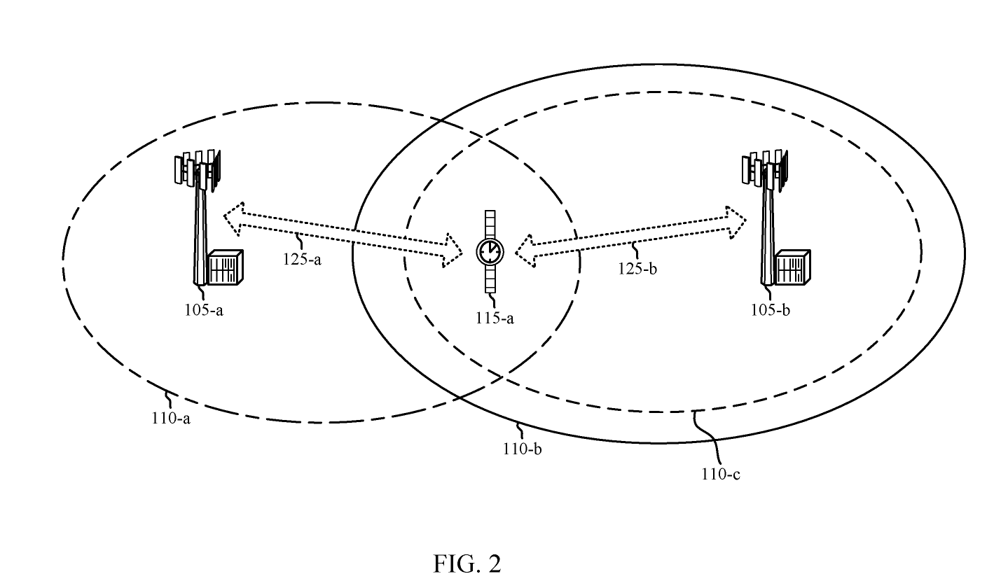

FIG. 2 illustrates an example of a wireless communications system 200 that supports power efficient dynamic RAT selection in accordance with various aspects of the present disclosure. Wireless communications system 200 includes a base station 105-a, a base station 105-b, and a wireless device 115-a. base station 105-a, base station 105-b, and wireless device 115-a may represent aspects of base stations 105 and wireless devices 115 as described with reference to FIG. 1. As shown, base station 105-a is capable of operating according to a first RAT (e.g., LTE) which supports communication with wireless device 115-a located within coverage area 110-a. base station 105-b is capable of operating according a second RAT (e.g., UMTS) and supports communication with wireless device 115-a located within coverage area 110-b. base station 105-b is also capable of operating according to a third RAT (e.g., HDR) which supports communication with wireless device 115-a located within coverage area 110-c.

In this example, wireless device 115-a is a wearable, IoT, or low power multimode device and is shown located within the intersection of coverage area 110-a (associated with the first RAT), coverage area 110-b (associated with the second RAT), and coverage area 110-c (associated with the third RAT). When wireless device 115-a wishes to transmit data (or receive data), the wireless device 115-a may choose to connect to the first RAT by establishing communication with base station 105-a over communication link 125-a. Alternatively, the wireless device 115-a may choose to connect to the second RAT or the third RAT by establishing communication with base station 105-b over communication link 125-b.

To select a RAT for communication, the wireless device 115-a determines power usage for transmitting a data packet using each RAT by initially determining the amount of data associated with the data packet to be transmitted. In some cases, the data packet may be fixed-length data packet that is transmitted periodically. Once the amount of data is determined, an estimated time for transmitting the data packet may be determined based at least in part on the throughput, modulation coding scheme (MCS), or average power associated with each RAT.

For instance, the wireless device 115-a may estimate that the first RAT (supported by base station 105-a) has the lowest estimated transmission time (e.g., due to high throughput), but may have the highest power usage (e.g., due to a high average power). However, the wireless device 115-a, being a low power device, may be incapable of utilizing the high throughput supported by the first RAT, so connecting to base station 105-a and transmitting using the first RAT is not efficient for the first RAT or the wireless device 115-a. The wireless device 115-a may also estimate that the second RAT and the third RAT (supported by base station 105-b) have higher estimated transmission times (e.g., due to lower throughput) than the estimated transmission time of the first RAT, but lower power usages (e.g., due to lower average power). In some cases, the wireless device 115-a may then determine that the channel conditions associated with the third RAT are poor which may result in multiple retransmissions and a higher estimated transmission time and power usage than the estimated transmission time and power usage determined for the second RAT. In such an example, the wireless device 115-a selects to connect with base station 105-b and operate according to the second RAT over communication link 125-b.

In some examples, the wireless device 115-a may consider a variance of the average power or a rate of change of power usage associated with each of the first RAT, the second RAT, and the third RAT when selecting a RAT for transmission. The wireless device 115-a may also selectively remove the option of connecting to a RAT as determinations are made. For example, after determining the throughput associated with the first RAT, the wireless device 115-a may eliminate the first RAT as a possibility for connection as the wireless device 115-a is incapable of utilizing the throughput of the first RAT. Thereafter, the wireless device 115-a may make further determinations of the first RAT and the second RAT (such as the variance of the average power or the rate of change of power usage of each of the first and second RATs). By making these (and other) additional determinations, the wireless device 115-a may be able to select a RAT corresponding with the lowest power usage for transmission of a data packet.

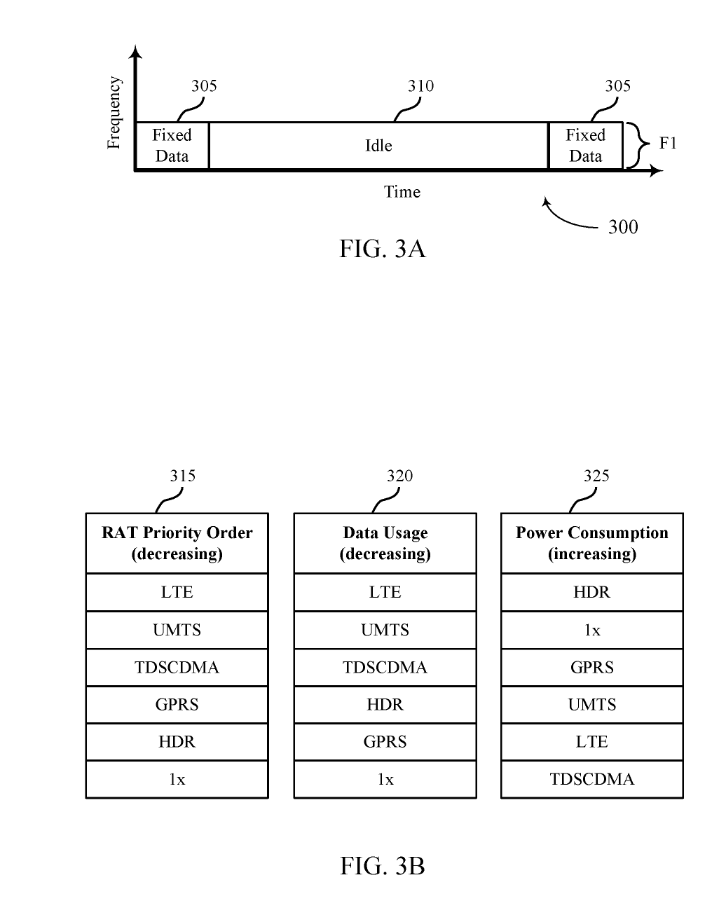

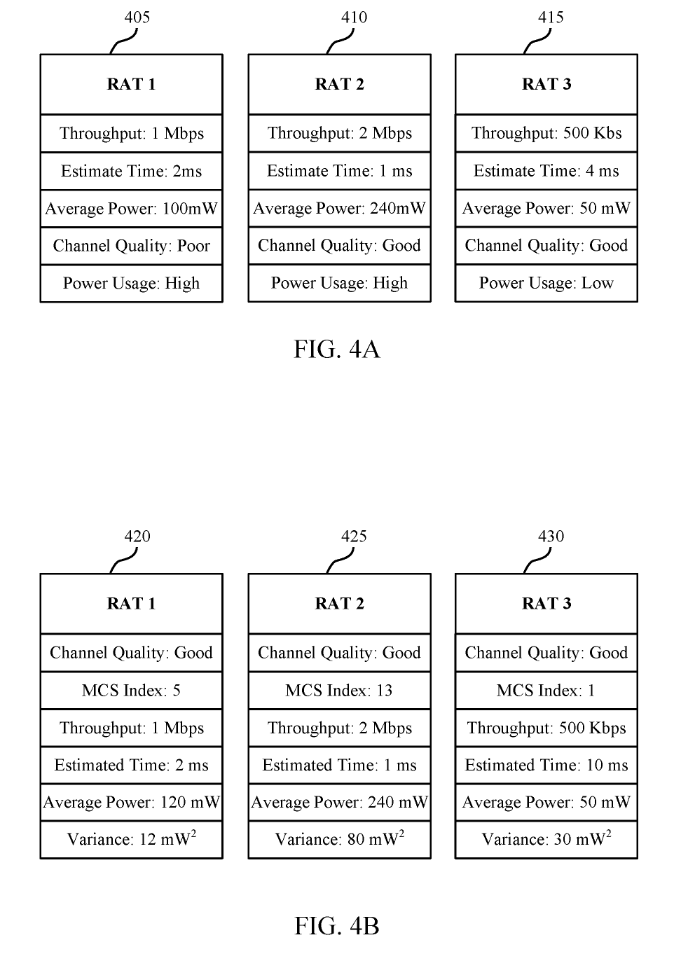

FIG. 3A illustrates an example of a frame structure 300 for power efficient dynamic RAT selection in accordance with various aspects of the present disclosure. In FIG. 3A, a frequency vs. time plot of a frame structure 300 is shown which represents resources allocated for a wireless device. As shown, a wireless device is allocated resources in channel F1, but remains inactive during most of the allocated time. For example, wireless device is shown having short awake cycles 305 where fixed data transmission occurs, and is separated by a long idle cycle 310 where the wireless device is inactive (i.e., transmission and reception do not occur). In some examples, and as shown in FIG. 3A, the awake cycles 305 of a wireless device are periodic. Because the wireless device remains inactive for most of the time allocated to the wireless device, multiple wireless devices may be assigned to the channel F1 at different time slots.

In FIG. 3A, a wireless device may only be allocated time slots corresponding to active cycles associated with the wireless device. In this manner, the wireless device has a maximum amount of time to transmit data. If the wireless device is transmitting a fixed amount of data associated with a data packet and has the option of transmitting using one of multiple RATs (e.g., if the wireless device is located within coverage areas for each of the multiple RATs), the wireless device may estimate a time for transmitting the fixed amount of data using each RAT. If an estimated transmission time for a given RAT exceeds the time allocated for the awake cycles 305, the wireless device eliminates the given RAT from consideration (even if the determined power usage is relatively low) as the wireless device cannot transmit the fixed amount of data using the given RAT in the limited time allocated for the awake cycles 305.

FIG. 3B illustrates examples of RAT tables that may be used for power efficient dynamic RAT selection in accordance with various aspects of the present disclosure. In FIG. 3B, a priority order table 315, a data usage table 320, and a power consumption table 325 is shown. The priority order table 315 may be predetermined by a wireless device, a base station, or another network entity and may be device or network specific in that the order may be determined based at least in part on the capabilities of the wireless device, the base station, or the network. The priority order table 315 may be stored by the wireless device to be used as a reference when determining a RAT for selection. For example, a wireless device may refer to the priority order table 315 if multiple RATs are available and may select an available RAT having the highest priority order (as shown in decreasing order in priority order table 315).

Data usage table 320 may include multiple RATs in order of data usage or throughput. The data usage table 320 may order RATs based at least in part on supported data rates, which may be determined by MCS capabilities, bandwidth capabilities, or the like. The data usage table 320 may be predetermined by a wireless device, a base station, or another network entity and may be stored by the wireless device to be used as a reference when determining a RAT for selection. For example, a wireless device may refer to the data usage table 320 if multiple RATs are available and the wireless device has a specific amount of data or quality of service (QoS) requirement. The wireless device may then select an available RAT having the highest data usage (as shown in decreasing order in data usage table 320).

In some examples, when multiple RATs are available, a wireless device may determine power usage for each of the available RATs and generate table of RATs ordered based at least in part on power consumption (as shown in power consumption table 325). In the power consumption table 325, multiple RATs are shown in order of least power consuming to greatest power consuming. By estimating transmission times as well as average power, variance, rate of power usage change, etc., a wireless device may generate or modify the power consumption table 325. The power consumption table 325 may also be modified based at least in part on channel conditions or other factors that contribute to the determination of power usage. On the other hand, in some cases, the power consumption table 325 may be predetermined by a base station, a wireless device, or another network entity and may include a list of RATs ordered by average power consumption over time in good channel condition scenarios. Such a table may then be references by a wireless device when determining power usage associated with available RATs.

Although the tables shown in FIG. 3B include RATs in a particular order, FIG. 3B serves as an example of different tables with multiple RATs in a certain order. Those having ordinary skill would appreciate that other tables, other orders, and other RATs may be considered without departing from the scope of the present disclosure.

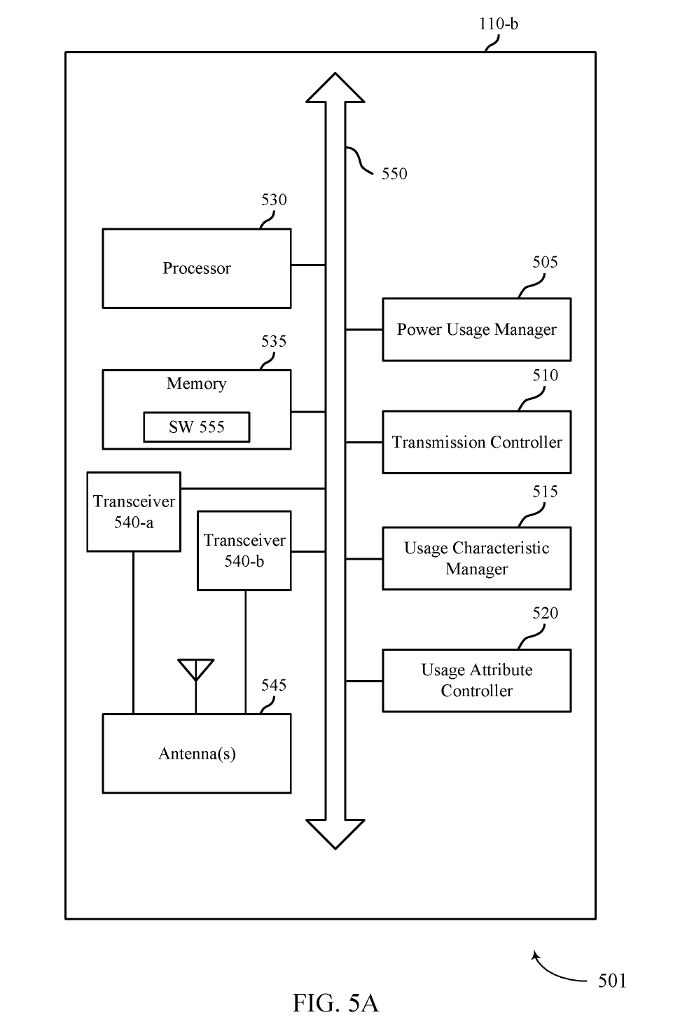

FIGS. 4A and 4B illustrate examples of RAT specific tables used for power efficient dynamic RAT selection in accordance with various aspects of the present disclosure. In FIG. 4A, a wireless device may determine power usage for three available RATs (RAT 1, RAT 2, and RAT 3). It may be determined that each RAT has different throughput capabilities and therefore different estimated times for transmitting a fixed amount of data associated with a data packet. As shown, RAT 1 (table 405) has a throughput of 1 Mbps, with a transmission time estimate of 2 ms. The average power for RAT 1 is 100 mW, and because of poor channel conditions, the power usage is high. RAT 2 (table 410) has the highest throughput of the threes RATs at 2 Mbps, with a transmission time estimate of 1 ms. Due to the higher throughput, the average power is higher (240 mW). With good channel conditions, the power usage estimate is high. RAT 3 (table 415) has the lowest throughput (500 Kbps) and the highest estimated transmission time (4 ms). RAT 3 also as the lowest average power (50 mW) and with good channel conditions, the power usage estimate is low. Based at least in part on the above, a wireless device may select RAT 3 as long as the active time allocated to the wireless device is at least 4 ms (the estimated time for transmitting the fixed amount of data using RAT 3).

In some examples, a wireless device may consider other factors of each available RAT. As shown in FIG. 4B, RAT 1 (table 420) now has good channel conditions with an MCS Index of 5, indicating a modulation type of 64-QAM with 1 spatial stream and a coding rate of 2/3. RAT 1 also shows a relatively low variance in average power of 12 mW². RAT 2 (table 425) still has good channel conditions with an MCS Index of 13, indicating a modulation type of 16-QAM with 2 spatial streams and a coding rate of 2/3. The variance is also relatively high (80 mW²) compared to the average power of 240 W. RAT 3 (table 430) still has good channel conditions with an MCS index of 1, indicating a modulation type of QPSK with a coding rate of 1/2. Though RAT 3 has a relatively low average power, the variance (30 mW) is large by comparison. Therefore, instead of selecting RAT 3 (as in FIG. 4A), a wireless device may consider connecting to RAT 1 because the variance may be too high for the wireless device to consider RAT 2 or RAT 3 or the wireless device may be incapable of 2 spatial streams (RAT 2). Therefore, after further consideration, the wireless device may select RAT 1 for data transmission.

Although the tables shown in FIGS. 4A and 4B include tables indicating various factors associated with different RATs, those having ordinary skill would appreciate that other factors, other orders, and other RATs may be considered without departing from the scope of the present disclosure.

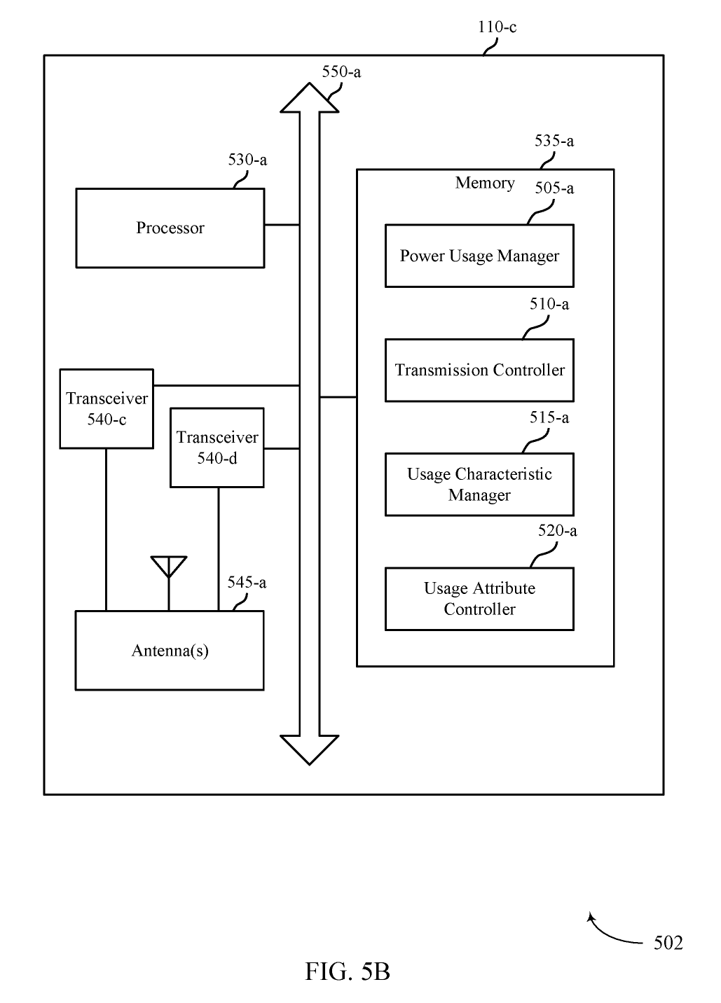

FIG. 5A shows a block diagram 501 of an example wireless device 115-b that supports power efficient dynamic RAT selection in accordance with various aspects of the present disclosure, and with respect to FIGS. 1-5. Wireless device 115-b includes a processor 530, a memory 535, one or more transceivers 540, and one or more antennas 545. Wireless device 115-b also includes power usage manager 505, transmission controller 510, usage characteristic manager 515, and usage attribute controller 520. Each component of wireless device 115-b is communicatively coupled with a bus 550, which enables communication between the components. The antenna(s) 545 are communicatively coupled with the transceiver(s) 540.

The processor 530 is an intelligent hardware device, such as one or more central processing units (CPUs), microcontrollers, application-specific integrated circuits (ASICs), etc. The processor 530 processes information received through the transceiver(s) 540 and information to be sent to the transceiver(s) 540 for transmission through the antenna(s) 545.

The memory 535 stores computer-readable, computer-executable software (SW) code 555 containing instructions that, when executed, cause the processor 530 or another one of the components of wireless device 115-b to perform various functions described herein, for example, determining power usages for multiple RATs.

The transceivers 540-a and 540-b communicate bi-directionally with other wireless devices, such as base stations 105, wireless devices 115, or other devices. The transceivers 540-a and 540-b may each include a modem to modulate packets and frames and provide the modulated packets to the antenna(s) 545 for transmission. The modem is additionally used to demodulate packets received from the antenna(s) 545. The transceivers 540-a and 540-b may support different RATs. For example, transceiver 540-a may support LTE, while transceiver 540-b may support EV-DO.

The power usage manager 505, transmission controller 510, usage characteristic manager 515, and usage attribute controller 520 implement the features described with reference to FIGS. 1-5, as further explained below.

FIG. 5A shows just one possible implementation of a device implementing the features of FIGS. 1-4. While the components of FIG. 5A are shown as discrete hardware blocks (e.g., ASICs, field programmable gate arrays (FPGAs), semi-custom integrated circuits, etc.) for purposes of clarity, it will be understood that each of the components may also be implemented by multiple hardware blocks adapted to execute some or all of the applicable features in hardware. Alternatively, features of two or more of the components of FIG. 5A may be implemented by a single, consolidated hardware block. For example, a single transceiver 540 chip may implement the processor 530, memory 535, power usage manager 505, transmission controller 510, usage characteristic manager 515, and usage attribute controller 520.

In still other examples, the features of each component may also be implemented, in whole or in part, with instructions embodied in a memory, formatted to be executed by one or more general or application-specific processors. For example, FIG. 5B shows a block diagram 502 of another example of a wireless device 115-c in which the features of the power usage manager 505-a, transmission controller 510-a, usage characteristic manager 515-a, and usage attribute controller 520-a are implemented as computer-readable code stored on memory 535-a and executed by one or more processors 530-a. Other combinations of hardware/software may be used to perform the features of one or more of the components of FIGS. 5A-5B. The transceivers 540-c and 540-d, bus 550-a, and antenna(s) 545-a may perform the functions described with reference to FIG. 5A.

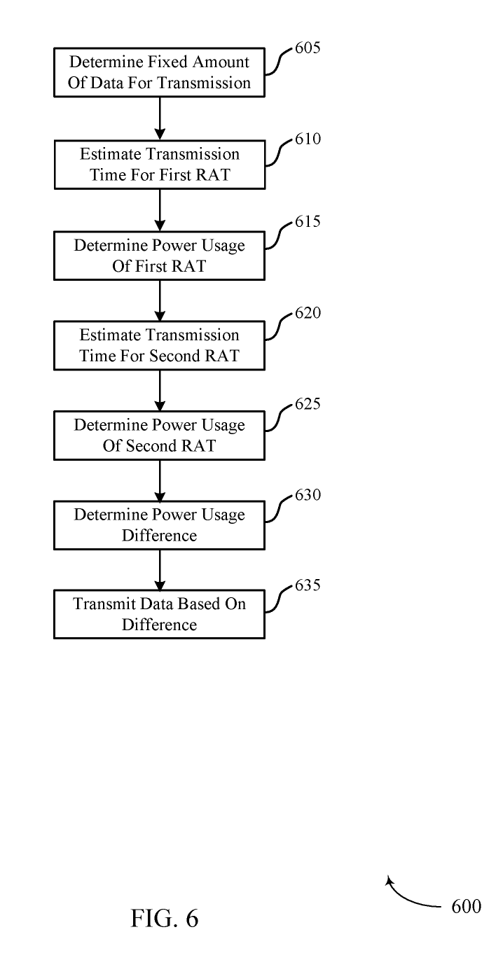

FIG. 6 shows a flow chart that illustrates one example of a method 600 for wireless communication, in accordance with various aspects of the present disclosure. The method 600 may be performed by any of the Wireless devices 115 discussed in the present disclosure, but for clarity the method 600 will be described from the perspective of the wireless device 115-b and wireless device 115-c of FIGS. 5A and 5B.

Broadly speaking, the method 600 illustrates a procedure by which the wireless device 115-b or wireless device 115-c determines power usage for a first RAT, determines power usage for a second RAT, and transmits a data packet using one of the first RAT or the second RAT (e.g., based at least in part on a difference in the determined power usages).

The method 600 begins with the wireless device 115-b or wireless device 115-c operating in wireless communications system such as wireless communications system 100 or wireless communications system 200 as described above with reference to FIGS. 1 and 2. The wireless device 115-b or wireless device 115-c has data pending for transmission. At block 605, power usage manager 505 determines the amount of data for transmission of a data packet. At block 610, power usage manager 505 estimates transmission time of the data packet if transmitted using the first RAT. In some examples, the transmission time may be estimated based at least in part on throughput of the first RAT as determined by usage characteristic manager 515. Thus, transmission time may be estimated for transmission of a fixed amount of data associated with a data packet if transmitted using the first RAT.

Proceeding to block 615, the power usage manager 505 determines a power usage of a first RAT. In some examples, the power usage of the first RAT may be based at least in part on the MCS associated with the first RAT, the transmission time estimated at block 610 or the amount of data determined at block 605. In some cases, power usage manager 505 may also determine power usage of the first RAT based at least in part on channel conditions associated with the first RAT. Further, the power usage may also depend on an average power for the first RAT, a variance in average power of the first RAT or a rate of change of power usage of the first RAT determined by usage attribute controller 520.

At block 620, power usage manager 505 estimates transmission time of the data packet if transmitted using a second RAT. In some examples, the transmission time may be estimated based at least in part on throughput of the second RAT as determined by usage characteristic manager 515. Thus, transmission time may be estimated for transmission of the fixed amount of data associated with the data packet if transmitted using the second RAT.

Proceeding to block 625, the power usage manager 505 determines a power usage of the second RAT. In some examples, the power usage of the second RAT may be based at least in part on the MCS associated with the second RAT, the transmission time estimated at block 620 or the amount of data determined at block 605. In some cases, power usage manager 505 may also determine power usage of the second RAT based at least in part on channel conditions associated with the second RAT. Further, the power usage may also depend on an average power for the second RAT, a variance in average power of the second RAT, or a rate of change of power usage of the second RAT determined by usage attribute controller 520.

At block 630, transmission controller 510 may determine a difference between the power usage for the first RAT determined at 615 and the power usage for the second RAT determined at 625. Based at least in part on the difference, the transmission controller 510 may determine to transmit the data packet using one of the first RAT or the second RAT. For example, if the power usage of the first RAT is determined to be lower than the power usage of the second RAT, the transmission controller may determine to transmit according to the first RAT. In some examples, the transmission controller may generate a table that includes the first RAT and the second RAT. The table may be ordered based at least in part on corresponding power usages, as determined, e.g., at block 615 and block 625. Therefore, the method 600 as implemented by a wireless device 115 may facilitate transmission of a data packet based at least in part on power usage. The power usage for a given RAT may be determined based at least in part on multiple factors associated with the given RAT such as channel conditions, MCS, throughput, estimate transmission time, variance, rate of change of power usage, etc.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications system 100 and 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication, comprising:
determining a first power usage of a first radio access technology (RAT) for transmission of a data packet based at least in part on a first estimated time to transmit a fixed amount of data associated with the data packet using the first RAT;
determining a second power usage of a second RAT for transmission of the data packet based at least in part on a second estimated time to transmit the fixed amount of data associated with the data packet using the second RAT; and
transmitting, based at least in part on the determined first power usage and the determined second power usage, the data packet according to one from the group consisting of the first RAT and the second RAT.

2. The method of claim 1, further comprising:
determining a first estimated throughput for the first RAT and a second estimated throughput for the second RAT; and
wherein the first power usage is based at least in part on the first estimated throughput and the second power usage is based at least in part on the second estimated throughput.

3. The method of claim 1, further comprising:
determining a first average power usage for the first RAT and a second average power usage for the second RAT; and
wherein the first power usage is based at least in part on the first average power usage and the second power usage is based at least in part on the second average power usage.

4. The method of claim 3, further comprising:
determining a variance of at least one of the first average power usage or the second average power usage; and
wherein at least one of the first power usage or the second power usage is based at least in part on the determined variance.

5. The method of claim 1, further comprising:
determining a rate of power usage change for at least one of the first RAT or the second RAT; and
wherein at least one of the first power usage or the second power usage is based at least in part on the determined rate of power usage change.

6. The method of claim 1, wherein at least one of the first power usage or the second power usage is based at least in part on a modulation and coding scheme (MCS) associated with at least one of the first RAT or the second RAT.

7. The method of claim 1, wherein at least one of the first power usage or the second power usage is based at least in part on channel conditions associated with at least one of the first RAT or the second RAT.

8. The method of claim 1, wherein transmitting the data packet comprises:
generating an ordered table including the first RAT and the second RAT, the ordered table being based at least in part on the determined first power usage and the determined second power usage; and
selecting one of the first RAT or the second RAT to transmit the data packet based at least in part on an ordering of the first RAT and the second RAT in the ordered table.

9. A communications device for wireless communication, comprising:
a first transceiver associated with a first RAT;
a second transceiver associated with a second RAT; and
a power usage manager to determine a first power usage of a first radio access technology (RAT) for transmission of a data packet based at least in part on a first estimated time to transmit a fixed amount of data associated with the data packet using the first RAT, and determine a second power usage of a second RAT for transmission of the data packet based at least in part on a second estimated time to transmit the fixed amount of data associated with the data packet using the second RAT; and
wherein the data packet is transmitted by one of the first transceiver or the second transceiver based at least in part on the determined first power usage and the determined second power usage, the data packet transmitted according to one from the group consisting of the first RAT and the second RAT.

10. The communications device of claim 9, further comprising:
a usage characteristic manager to determine a first estimated throughput for the first RAT and a second estimated throughput for the second RAT;
wherein the first power usage is based at least in part on the first estimated throughput and the second power usage is based at least in part on the second estimated throughput.

11. The communications device of claim 9, further comprising:
a usage attribute controller to determine a first average power usage for the first RAT and a second average power usage for the second RAT; and
wherein the first power usage is based at least in part on the first average power usage and the second power usage is based at least in part on the second average power usage.

12. The communications device of claim 11, wherein the usage attribute controller is further to:
determine a variance of at least one of the first average power usage or the second average power usage; and
wherein at least one of the first power usage or the second power usage is based at least in part on the determined variance.

13. The communications device of claim 9, further comprising:
a usage attribute controller to determine a rate of power usage change for at least one of the first RAT or the second RAT; and
wherein at least one of the first power usage or the second power usage is based at least in part on the determined rate of power usage change.

14. The communications device of claim 9, wherein at least one of the first power usage or the second power usage is based at least in part on a modulation and coding scheme (MCS) associated with at least one of the first RAT or the second RAT.

15. The communications device of claim 9, wherein at least one of the first power usage or the second power usage is based at least in part on channel conditions associated with at least one of the first RAT or the second RAT.

16. The communications device of claim 9, further comprising a transmission controller to:
generate an ordered table including the first RAT and the second RAT, the ordered table being based at least in part on the determined first power usage and the determined second power usage; and
select one of the first RAT or the second RAT to transmit the data packet based at least in part on an ordering of the first RAT and the second RAT in the ordered table.

17. A non-transitory computer readable medium storing code for wireless communication, the code comprising instructions executable by a processor to:
determine a first power usage of a first radio access technology (RAT) for transmission of a data packet based at least in part on a first estimated time to transmit a fixed amount of data associated with the data packet using the first RAT;
determine a second power usage of a second RAT for transmission of the data packet based at least in part on a second estimated time to transmit the fixed amount of data associated with the data packet using the second RAT; and
transmit, based at least in part on the determined first power usage and the determined second power usage, the data packet according to one from the group consisting of the first RAT and the second RAT.

18. The non-transitory computer-readable medium of claim 17, wherein the instructions are further executable by the processor to:
determine a first estimated throughput for the first RAT and a second estimated throughput for the second RAT; and
wherein the first power usage is based at least in part on the first estimated throughput and the second power usage is based at least in part on the second estimated throughput.

19. The non-transitory computer-readable medium of claim 17, wherein the instructions are further executable by the processor to:
determine a first average power usage for the first RAT and a second average power usage for the second RAT; and
wherein the first power usage is based at least in part on the first average power usage and the second power usage is based at least in part on the second average power usage.

20. The non-transitory computer-readable medium of claim 19, wherein the instructions are further executable by the processor to:
determine a variance of at least one of the first average power usage or the second average power usage; and
wherein at least one of the first power usage or the second power usage is based at least in part on the determined variance.
